(19) United States
(12) Patent Application Publication
(10) Pub. No.: US 2021/0370603 A1
(43) Pub. Date: Dec. 2, 2021

(54) FLUID FLOW DEVICES FOR PRINTERS

(71) Applicant: HEWLETT-PACKARD DEVELOPMENT COMPANY, L.P., Spring, TX (US)

(72) Inventors: Theodore J. Conley, Vancouver, WA (US); Robert Lawrence Winburne, Vancouver, WA (US)

(21) Appl. No.: 16/608,475

(22) PCT Filed: Jul. 18, 2018
(86) PCT No.: PCT/US2018/042680

§ 371 Date: Oct. 25, 2019

(51) Int. Cl. B29C 64/329; B29C 64/245

(52) U.S. Cl. CPC B29C 64/329; B33Y 30/00; B29C 64/245

(57) ABSTRACT

Examples of a fluid flow device for an additive manufacturing printer are disclosed. In an implementation, the fluid flow device includes a body including an inlet, an outlet, a first wall, a second wall opposite the first wall, and a fluid flow passage in fluid communication with the inlet and outlet. In addition, the fluid flow device includes a port into the fluid flow passage, through the first wall along an axis, the port to communicate with a chamber that receives powder during a printing operation. Further, the fluid flow device includes a plate within the fluid flow passage and axially spaced between the port and the second wall such that the fluid flow passage is divided into a first passage between the port and the plate and a second passage between the plate and the second wall, the first passage to receive powder from the chamber through the port.

### BACKGROUND

Additive manufacturing style printers, such as three-dimensional (3D) printers, may utilize powdered building materials to print the manufactured or printed object. The powdered building material may be circulated through the printer during the printing operation and can sometimes cause clogs or blockages which should be cleared to enable efficient and proper operations with the printer.

### BRIEF DESCRIPTION OF THE DRAWINGS

Various examples will be described below referring to the following figures:

FIG. 1 shows a schematic view of a system for conducting an additive manufacturing process according to least some examples.

FIG. 2 shows a perspective view of one of the fluid flow devices for use within the system of FIG. 1 according to at least some examples.

FIG. 3 shows a top view of the fluid flow device of FIG. 2.

FIG. 4 shows a cross-sectional view of the fluid flow device of FIG. 2 along section A-A in FIG. 3.

FIG. 5 shows a cross-sectional view of the fluid flow device of FIG. 2 along section B-B in FIG. 3.

FIG. 6 shows a perspective cross-sectional view of the fluid flow device of FIG. 2 secured to a chamber of the system of FIG. 1 and filled with powder from an additive manufacturing process according to at least some examples.

FIG. 7 is a side cross-sectional view of the fluid flow device of FIG. 2 coupled to a reservoir that has received a powder from an additive manufacturing process according to at least some examples.

FIG. 8 is a front cross-sectional view of the fluid flow device of FIG. 2 coupled to a reservoir that has received a powder from an additive manufacturing process according to at least some examples.

### DETAILED DESCRIPTION

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the following discussion and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis.

As used herein, including in the claims, the word “or” is used in an inclusive manner. For example, “A or B” means any of the following: “A” alone, “B” alone, or both “A” and “B.” In addition, when used herein, including the claims, the word “generally” or “substantially” means within a range of plus or minus 20% of the stated value. As used herein, the terms “downstream” and “upstream” are used to refer to the arrangement of components and features within a printer with respect to the “flow” of print media through the printer during a printing operation. Thus, if a first component of a printer receives print media after it is output from a second component of the printer during a printing operation, then the first component may be said to be “downstream” of the second component and the second component may be said to be “upstream” of the first component.

As previously described, the powdered building material used within an additive manufacturing printer (e.g., a 3D printer) may cause clogs or other flow restrictions as it is circulated about the printer. These flow stoppages can hinder printing operations, and may even cause damage to components of the printer (e.g., due to pressure increases). Accordingly, examples disclosed herein include fluid flow devices for use within an additive manufacturing printer that prevent (or reduce) the occurrence of clogs, blockages, or restrictions and promote a relatively constant flow of powdered building materials within the printer during operations. As a result, use of the disclosed fluid flow devices may improve the reliability and efficiency of such 3D printers.

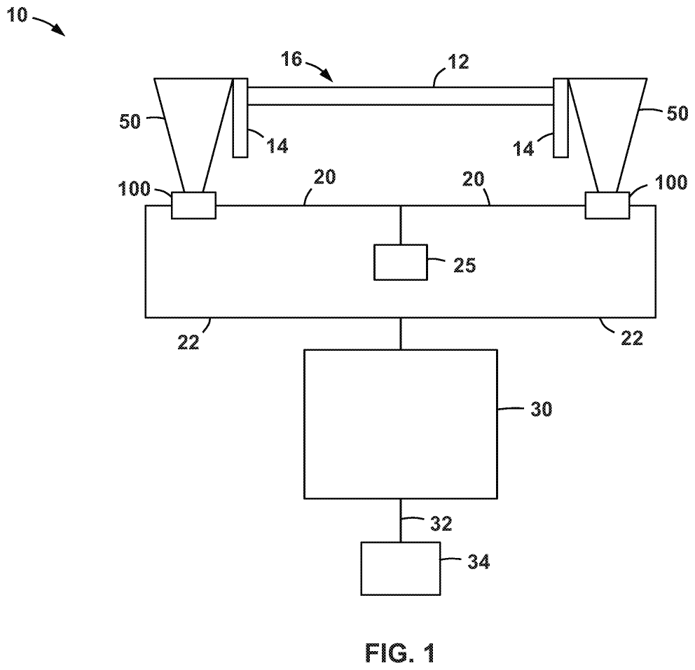

Referring now to FIG. 1, a system 10 for conducting an additive manufacturing process is shown. In this example, the additive manufacturing process is a 3D printing process, and thus, system 10 may be referred to herein as printing system 10. Printing system 10 generally includes a build surface or platform 12, a plurality of overflow troughs or chambers 50 disposed adjacent to surface 12, a plurality of fluid flow devices or nozzles 100 each coupled to one of the chambers 50, a storage reservoir 30, and a vacuum source 34. As used herein, the terms “fluid flow device” and “nozzle” refer to a generally enclosed device or housing that channels or directs fluid (e.g., air) therethrough, between an inlet and an outlet.

Build surface 12 is a substantially flat surface that supports a three-dimensional (3D) printed object. Surface 12 is movably disposed between a plurality of walls 14. During operations, surface 12 may be disposed vertically below a topmost end of the walls 14 such that a chamber or vessel 16 is defined by the walls 14 and surface 12 that is open at a vertical upper end.

During a printing operation, powdered building material is flowed, dumped, poured or otherwise provided into vessel 16. The powdered building material (which may be more simply referred to herein as a “powder”) may comprise any suitable powdered material for use within a 3D printing operation, such as, for example, powders comprising plastics, metals, ceramics, or combinations thereof. Thereafter, a roller or other skimming member (not shown) is moved laterally over surface 12 (and vertically spaced above surface 12 by a predetermined amount) to skim excess powder into chambers 50, and to ensure that the upper surface of the powder is substantially flat or planar in the lateral direction. In some implementations, the powder is first deposited on a separate platform or surface (not shown) that is adjacent to the build surface 12, and thereafter, the powder is spread (e.g., via a roller or other suitable device) from this adjacent platform onto the build surface 12.

After the surface of the powder is flattened (or simultaneously with flattening the surface of the powder), a printing mechanism (e.g., a print head, roller, or combination thereof) deposits a layer of printing agent (which may comprise a printing liquid such as ink in some implementations) onto the powder within vessel 16 in a desired pattern, such as, for example, the outline of a two-dimensional section of the three-dimensional object to be printed. In this example, the printing agent deposited onto the powder is a darker color than the surrounding powder material.

After the printing agent has been deposited on the powder, energy (e.g., such as light, heat, radiation, or some combination thereof) is directed at the powder within vessel 16. Because of the relatively darker color of the printing agent that was previously printed onto the powder, a relatively higher amount of energy is absorbed by the printing agent (and thus the powder bearing the printing agent thereon) so that the powder bearing the printing agent melts and fuses. In other implementations, the printing agent may or may not be darker than the surrounding powder material, and may also include other material properties (e.g., such as chemical composition or structure) that allow the printing agent to absorb a relatively higher amount of energy to therefore facilitate the melting and fusing operations previously described above. As a result, applying energy to the printed printing agent produces a fused layer of material that matches, or closely matches, the outline of the two-dimensional section that was previously printed on the powder. Following this fusing operation, the surface 12 is lowered a predetermined amount relative to the walls 14 and a fresh layer of powder is deposited on top of the previously fused powder layer within vessel 16. Thereafter, the above described operations are repeated to form another 2D layer of the 3D object. As each layer of powder fuses to itself in the manner described above, the powder forming each 2D layer also fuses or otherwise binds to the immediately adjacent 2D layer below it. Accordingly, through this process, a 3D object is built or printed layer by layer within vessel 16.

As can be appreciated from the above described printing operation, a large amount of excess powder can be expelled from vessel 16 into adjacent chambers 50 with the printing of each successive 2D layer. This excess powder is circulated out of chambers 50 and back to a storage reservoir 30, such that the powder can be either disposed of or reused. In particular, air (or some other fluid) is drawn into an intake 25 (or plurality of intakes) through a plurality of lines or conduits 20 by vacuum source 34, that is coupled to reservoir 30 via a conduit 32 and which may comprise any suitable pump(s), compressor(s), or combination thereof. The air flows through fluid flow devices 100 which are in communication with chambers 50 and entrains powder that falls into fluid flow devices 100 from chambers 50. As a result, the powder is carried from fluid flow devices 100 by the air, through lines 22, and into reservoir 30. Lines or conduits 20, 22, 32 may comprise any suitable conduit capable of delivering a flow of fluid therethrough, such as, for example, pipes, hoses, channels, etc.

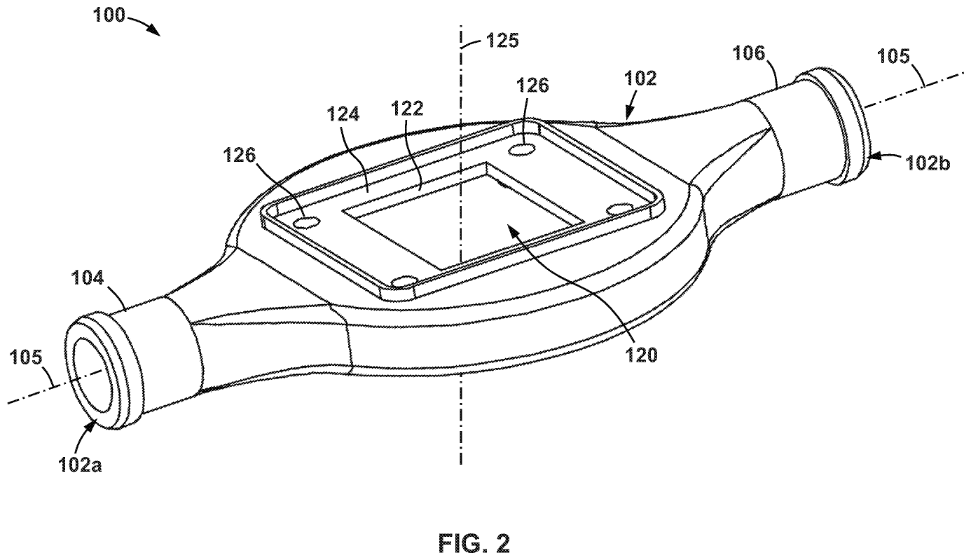

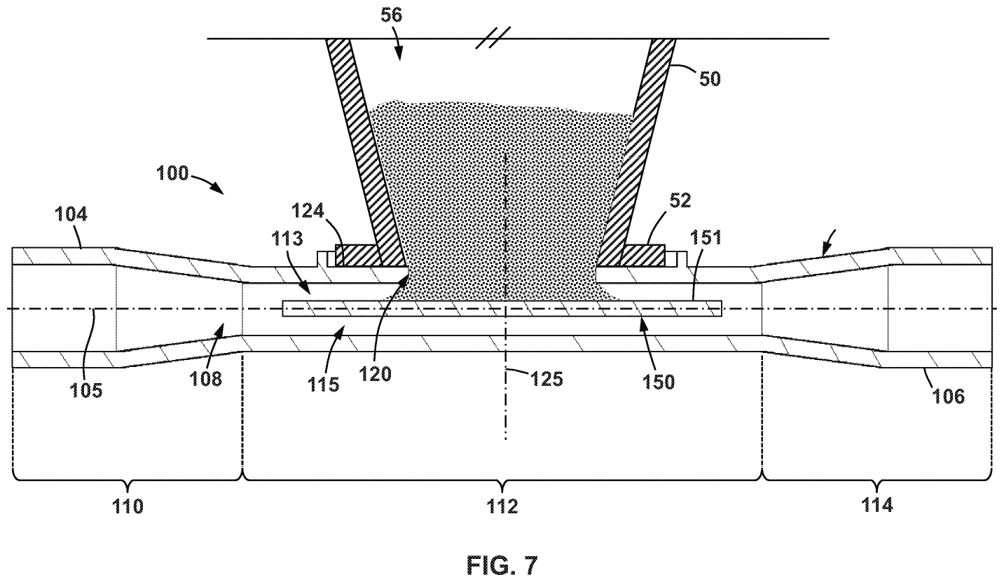

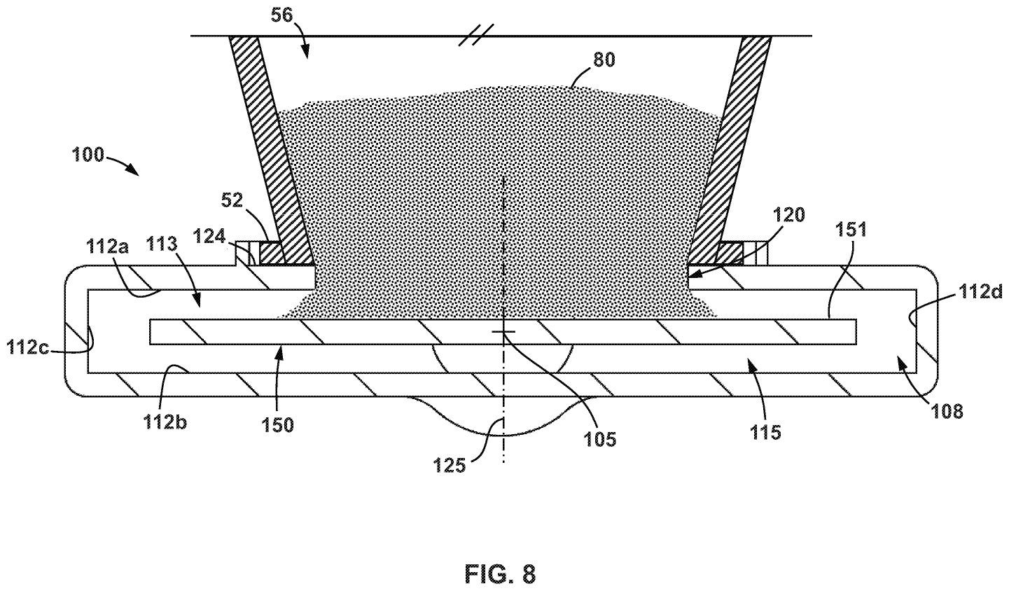

As will be described in more detail below, fluid flow devices 100 are arranged to provide a relatively constant flow of powder into lines 22 and to reduce and prevent blockages or other flow restrictions therein. As a result, the pressure within lines 20, 22, 32 may remain relatively constant and the pressure increases often associated with flow restrictions are reduced or eliminated. Further details regarding the fluid flow devices 100 are described herein with general reference to FIGS. 2-8.

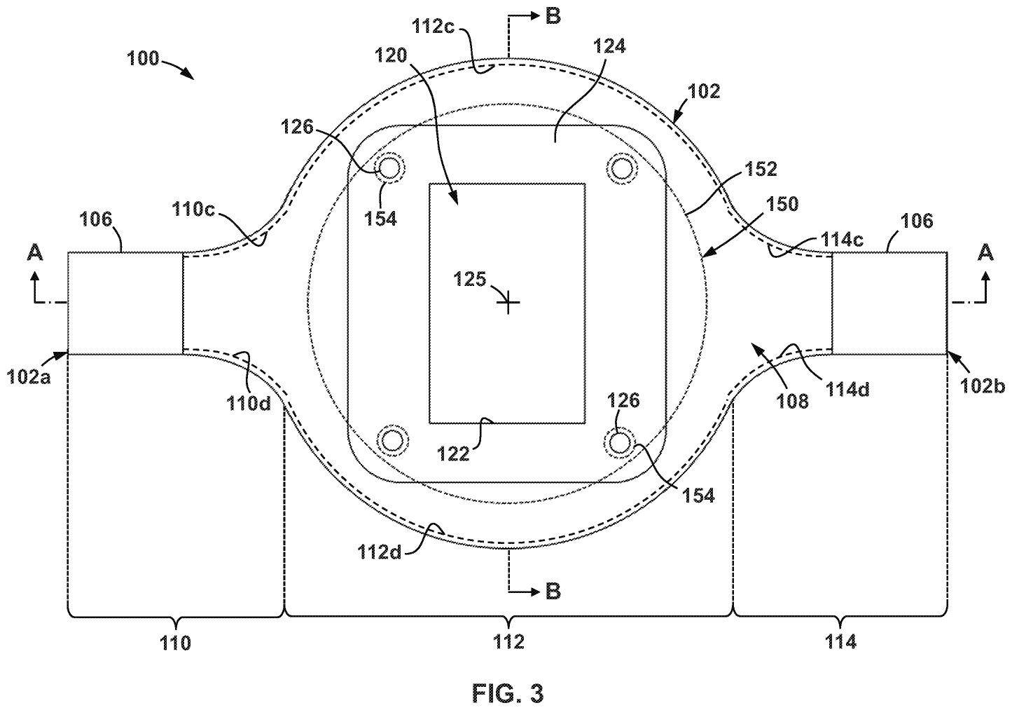

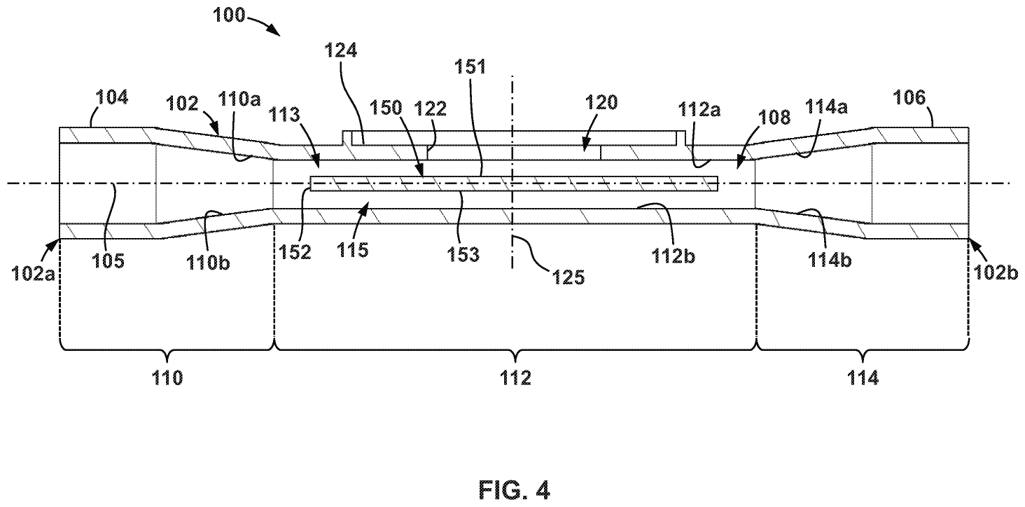

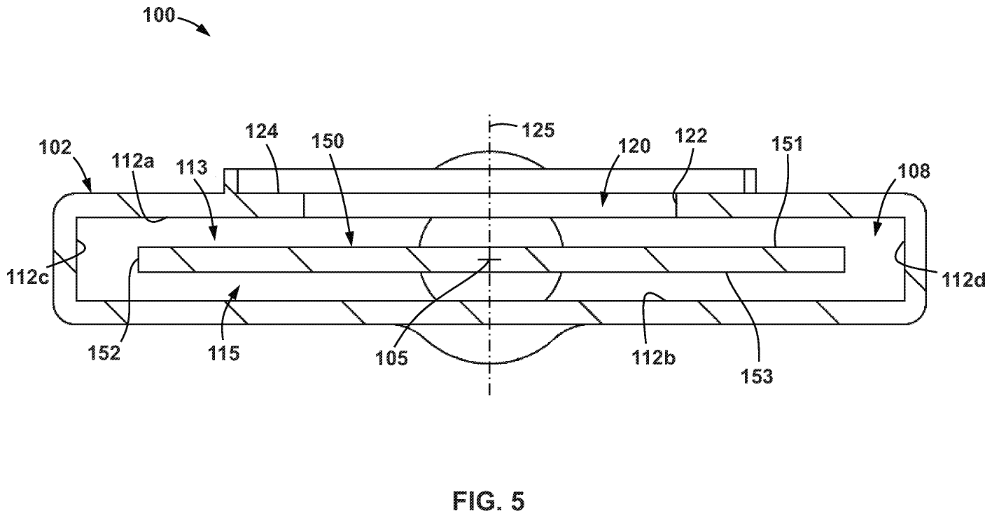

Referring now to FIGS. 2-5, one of the fluid flow devices 100 is shown, it being appreciated that the other fluid flow devices 100 in system 10 are the same. In this example, fluid flow device 100 includes a body 102 having a central or longitudinal axis 105, a first or upstream end 102a, and a second or downstream end 102b opposite upstream end 102a. In addition, as best shown in FIGS. 4 and 5, body 102 defines a fluid flow passage or chamber 108 extending between ends 102a, 102b. Body 102 also includes an inlet 104 at upstream end 102a and an outlet 106 at downstream end 102b, where the inlet 104 and outlet 106 provide fluid communication into and out of fluid flow passage 108, respectively. Referring briefly to FIGS. 1-3, during operations, inlet 104 is coupled to one of the lines 20, and outlet 106 is coupled to one of the lines 22 within system 10 such that vacuum source 34 may induce a flow of fluid (e.g., air) through fluid flow device 100 from inlet 104, through flow passage 108 and out of outlet 106. In addition, as best shown in FIG. 3, inlet 104 and outlet 106 are generally coaxially aligned along axis 105.

Referring again to FIGS. 2-5, fluid flow passage 108 includes a first or inlet section 110 extending from and including inlet 104, a second or outlet section 114 extending from and including outlet 106, and a central section 112 extending between inlet section 110 and outlet section 114. As shown is FIG. 4, inlet section 110 includes a pair of opposing top and bottom walls 110a, 110b, respectively, that converge toward one another when moving axially from inlet 104 toward central section 112. As shown in FIG. 3, walls 110a, 110b are radially opposite one another about axis 105. Similarly, as shown in FIG. 4, outlet section 114 includes a pair of opposing top and bottom walls 114a, 114b, respectively, that diverge away from one another when moving axially from central section 112 toward outlet 106. Further, as best shown in FIG. 3, inlet section 110 includes a pair of opposing side walls 110c, 110d that diverge away from one another when moving axially from inlet 104 toward central section 112. Side walls 110c, 110d are radially opposite one another about axis 105 and each extends between the opposing top and bottom walls 110a, 110b, respectively. Similarly, outlet section 114 includes a pair of opposing side walls 114c, 114d that converge toward one another when moving axially from central section 112 toward outlet 106. Side walls 114c, 114d are radially opposite one another about axis 105 and each extends between the opposing walls 114a, 114b.

As is best shown in FIG. 4, central section 112 includes a pair of opposing top and bottom walls 112a, 112b that are radially opposite one another about axis 105. In this example, walls 112a, 112b extend parallel to one another with top wall 112a extending axially from top wall 110a of inlet section 110 to top wall 114a of outlet section 114 and with bottom wall 112b extending axially from bottom wall 110b of inlet section 110 to bottom wall 114b of outlet section 114. In addition, and as best shown in FIG. 3, central section 112 includes a pair of opposing side walls 112c, 112d that are also radially opposite one another about axis 105, where the side walls 112c, 112d extend between the walls 112a, 112b. Side wall 112c extends from side wall 110c of inlet section 110 to side wall 114c of outlet section 114, and side wall 112d extends from side wall 110d of inlet section 110 to side wall 114d of outlet section 114. In this example, side walls 112c, 112d are curved (e.g., circularly curved in the plane of FIG. 3), so that walls 112c, 112d are radially farthest from axis 105 at a midpoint between inlet section 110 and outlet section 114.

Referring again to FIGS. 2-5, a hole or port 120 extends radially into central section 112 through top wall 112a along a central axis 125 that is disposed within a plane that is perpendicular to axis 105. In this example, axis 125 is orthogonal (or perpendicular) to axis 105 (however, axes 125, 105 are not so aligned in other implementations). Port 120 may be formed of any suitable shape or size, and, in this example, port 120 has a rectangular radial cross-section with respect to axis 125 and includes a plurality of perimeter walls 122 that define a radial cross-sectional area for port 120 with respect to axis 125. Body 102 also includes a mounting flange 124 that is disposed about port 120. Mounting flange 124 includes a plurality of mounting apertures 126 that extend into body 102 in a direction that is parallel to axis 125. As will be described in more detail below, mounting flange 124 (including apertures 126) facilitates the coupling of fluid flow device 100 to a corresponding one of the chambers 50.

A plate 150 is mounted within central section 112 of fluid flow passage 108 that is axially spaced from and disposed between walls 112a, 112b along axis 125. Plate 150 includes a first or upper side 151, a second or lower side 153 axially opposite upper side 151 along axis 125, and a radially outermost perimeter edge 152 that extends axially between sides 151, 153 along axis 125. In this example, plate 150 includes a circular radial cross-section with respect to axis 125, so that each side 151, 153 is circular in shape. However, it should be appreciated that plate 150 may comprise any suitable shape or size, in other implementations, such as, for example, rectangular, square, oval, triangular, etc.

In this example, plate 150 is axially spaced from top wall 112a and port 120 and is axially spaced from bottom wall 112b along axis 125. As a result, upper side 151 is axially spaced from port 120 and top wall 112a and lower side 153 is axially spaced from bottom wall 112b with respect to axis 125. In this example, plate 150 is axially equidistant from top wall 112a (and thus port 120) and bottom wall 112b; however, in other examples plate 150 may be disposed axially closer to top wall 112a (and port 120) than bottom wall 112b, or may be disposed axially closer to bottom wall 112b than top wall 112a (and port 120). Therefore, plate 150 divides central section 112 of fluid flow passage 108 into a first or upper passage 113 axially between upper side 151 of plate 150 and port 120 (and top wall 112a) and a second or lower passage 115 axially between lower side 153 of plate 150 and bottom wall 112b.

In addition, in this example, plate 150 is coaxially aligned with port 120 along axis 125 and has a larger radial cross-sectional area than the port 120 with respect to axis 125. In addition, radially outer perimeter edge 152 of plate 150 is disposed radially farther from axis 125 than perimeter walls 122 of port 120 along the entire perimeters of port 120 and plate 150 (i.e., outer perimeter edge 152 of plate 150 is disposed radially outside of perimeter walls 122 of port 120 about the entire perimeters of plate 150 and port 120).

Further, as is best shown in FIG. 5, plate 150 is disposed within central section 112 of fluid flow passage 108 such that the radially outer perimeter edge 152 is radially spaced from both of the side walls 112c, 112d. As a result, fluids (e.g., air) flowing through central section 112 of fluid passage 108 between inlet 104 and outlet 106 are able to flow around and across sides 151, 153 and edges 152 of plate 150. Specifically, fluid flowing between inlet 104 and outlet 106 may flow between plate 150 and upper wall 112a (and port 120) (i.e., within upper passage 113), between plate 150 and bottom wall 112b (i.e., within lower passage 115), between plate 150 and side wall 112c, and between plate 150 and side wall 112d. Because sides 151, 153 extend radially with respect to axis 125, fluid flowing through fluid flow passage 108 (specifically through central section 112) may flow across sides 151, 153 in a radial direction. Still further and as best shown in FIG. 3, in this example, plate 150 is mounted within fluid flow passage 108 by a plurality of mounting columns 154 extending between walls 112a, 112b that are each also aligned with one of the mounting apertures 126, previously described.

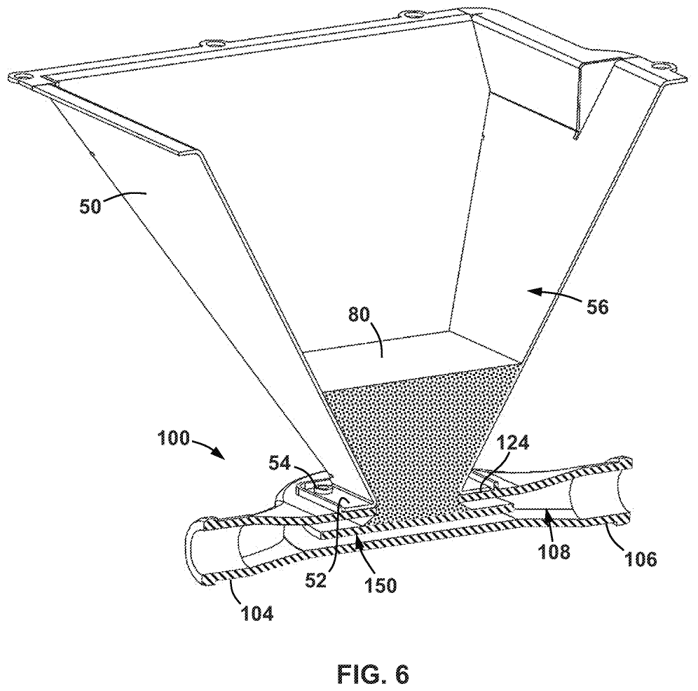

Referring now to FIGS. 6-8, to utilize fluid flow device 100 within printing system 10, fluid flow device 100 is coupled to one of the chambers 50 via mounting flange 124. In particular, a corresponding mounting flange 52 on chamber 50 is engaged with mounting flange 124 such that mounting apertures 126 on flange 124 (see FIG. 3) are aligned with corresponding mounting apertures (not shown) in mounting flange 52 and mounting members 54 (e.g., screws, bolts, rivets, etc.) are inserted through the aligned apertures (e.g., aperture 126 shown in FIG. 3) to secure flanges 124, 52 to one another. When chamber 50 and fluid flow device 100 are coupled to one another via flanges 124, 52 as described and shown, an internal volume 56 of chamber 50 is in communication with fluid flow passage 108 (specifically upper passage 113 of central section 112) via port 120. In this example, the coupled chamber 50 and fluid flow device 100 are arranged such that the axis 125 is generally aligned with the direction of gravity (i.e., axis 125 is substantially aligned with the vertical direction). As a result, powder 80 that is disposed within internal volume 56 of chamber 50 flows (or falls), under the force of gravity, through port 120 and into contact with upper side 151 of plate 150 within upper passage 113.

Referring still to FIGS. 1 and 6-8, during a printing operation, excess powder 80 is swept or otherwise provided to the internal volume 56 of chamber 50 from the vessel 16 (see FIG. 1) as previously described above. Upon entering internal volume 56 of chamber 50, the powder 80 falls or otherwise flows downward toward port 120 and enters upper passage 113 of fluid flow passage 108 therethrough. Because the radial cross-sectional area of plate 150 is larger than the radial cross-sectional area of port 120 with respect to axis 125 as previously described, upon entering upper passage 113, the powder 80 collects upon upper side 151 of plate 150 within upper passage 113 and does not enter the other portions of fluid flow passage (e.g., lower passage 115) and does not flow or extend to or past the radially outer perimeter edge 152 of plate 150. Various parameters and dimensions are chosen to prevent the prevent powder 80 from overflowing past (or even to) outer perimeter edge 152 of plate 150 within flow passage 108 during operations. For example, such dimensions may include the axial distance between upper side 151 of plate 150 and port 120 along axis 125, and the relative radial cross-sectional areas of plate 150 and port 120. Thus, plate 150 prevents powder 80 from advancing out of the upper passage 113 and thus from ultimately filling the entire fluid flow passage 108 (or at least the central section 112 of flow passage 108). Accordingly, plate 150 ensures that lower passage 115, and the spaces extending radially between side walls 112c, 112d, and plate 150 (e.g., outer perimeter edge 152), with respect to axis 125, remains open as powder 80 flows into fluid flow device 100 from chamber 50 via port 120 during printing operations.

During a printing operation, fluid (e.g., air) is flowed through fluid flow passage 108, between the inlet 104 and outlet 106 to transport powder 80 from upper side 151 of plate 150 to outlet 106. In particular, an air flow is induced through fluid flow device 100 via the vacuum source 34 as previously described such that powder 80 exiting outlet 106 may be provided to reservoir 30 via lines 22. Because powder 80 is retained within a portion of upper passage 113 as previously described, the air flowing through fluid flow device 100 is allowed to flow freely through the lower passage 115 and radially (with respect to axis 125) between plate 150 and side walls 112c, 112d. Thus, a minimum flow of air is maintained through fluid flow device 100 during printing operations, regardless of whether powder 80 is disposed within upper passage 113 via port 120. In addition, during these operations, the air flowing through fluid flow device 100 may also flow within upper passage 113 around the pile of powder 80 disposed on upper side 151 of plate 150. As the fluid flows past the powder 80 within upper passage 113, particles of the powder are entrained in the flowing fluid and are carried or swept from fluid flow passage 108 via outlet 106. Thereafter, the powder 80 is carried to reservoir 30 (see FIG. 1) via conduit(s) 22 for storage, disposal, and/or reuse as previously described.

Accordingly, because plate 150 ensures a minimum flow rate through fluid flow passage 108, when powder 80 is provided from chamber 50 via port 120, fluid flow device 100 provides a relatively constant and consistent flow rate of powder 80 to reservoir 30. A constant (or relatively constant) flow rate of powder 80 between fluid flow device 100 and reservoir 30 is desirable since it avoids (or reduces) the occurrence of slug flow and the pressure spikes or increases which are associated with such a flow scheme. These pressure increases can cause wear and failure (e.g., fatigue, overpressure, etc.) for components of the printer system (e.g., vacuum source 34, lines 20, 22, 32, etc.). As a result, the use of the example fluid flow device 100 disclosed herein may increase the useable life of components within printing system 10. In addition, by avoiding slug flow and flow restrictions (the associated pressure variations associated therewith), the load on the vacuum source 34 remains relatively constant so that the sizing and performance of vacuum may be optimized for increased efficiency and cost-effectiveness.

Further, without being limited to this or any other theory, flow rate of powder 80 from fluid flow device 100 may be a function of the exposed surface area of the powder 80 to the flowing fluid, and this exposed surface area is a direct result of the axial spacing between the plate 150 and port 120 along axis 125 and of the characteristics of the powder 80. Therefore, adjustments in the flow rate of powder 80 from fluid flow device 100 may be achieved by, for example, adjusting the axial spacing of plate 150 from port 120 within fluid flow passage 108.

Examples disclosed herein have provided fluid flow devices for use within an additive manufacturing printer (e.g., fluid flow device 100) that prevent (or reduce) the occurrence of clogs, blockages, or restrictions in the flow of powdered building materials within the printer. In addition, the fluid flow devices disclosed herein promote a relatively constant flow rate of powdered printing material through the printer. Accordingly, through use of the fluid flow devices disclosed herein, the reliability and efficiency of an additive manufacturing style printer (e.g., printing system 10) may be increased.

While examples of the fluid flow devices disclosed herein (e.g., fluid flow device 100) have been used to flow excess powder provided to chambers that are adjacent a build surface (e.g., surface 12) within an additive manufacturing style printer, it should be appreciated that the fluid flow devices may be utilized in other portions of printing system 10 in other implementations. For example, in some implementations, the fluid flow devices may be used to flow or deliver fluid falling through holes disposed in the printer build chamber (e.g., through holes disposed in surface 12) to a reservoir (e.g., reservoir 30) for later reuse, or disposal.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A fluid flow device for a printer, the fluid flow device comprising:
a body comprising an inlet, an outlet, a first wall, a second wall opposite the first wall, and a fluid flow passage disposed between the first wall and the second wall and in fluid communication with the inlet and the outlet;
a port extending into the fluid flow passage and through the first wall along a central axis, the port to communicate with a chamber that receives powder during a printing operation; and
a plate disposed within the fluid flow passage and axially spaced between the port and the second wall such that the fluid flow passage is divided into a first passage between the port and the plate and a second passage between the plate and the second wall, wherein the first passage is to receive powder from the chamber through the port.

2. The fluid flow device of claim 1, wherein the plate extends radially relative to the central axis.

3. The fluid flow device of claim 2, wherein the plate has a larger radial cross-sectional area than the port.

4. The fluid flow device of claim 3, wherein the fluid flow passage is to facilitate radially-directed fluid flow across the plate and between the inlet and the outlet.

5. The fluid flow device of claim 4, wherein the fluid flow passage comprises:
an inlet section including the inlet;
a central section; and
an outlet section including the outlet;
wherein the outlet section is in fluid communication with the inlet section through the central section,
wherein the plate is disposed in the central section, and
wherein the inlet section includes a pair of opposed walls that converge from the inlet toward the central section and the outlet section includes a pair of opposed walls that diverge from the central section toward the outlet.

6. A system, comprising:
a build surface to support a three-dimensional printed object;
a chamber disposed adjacent the build surface to receive material from the build surface; and
a fluid flow device coupled to the chamber, wherein the fluid flow device comprises:
a body comprising an inlet, an outlet, a first wall, a second wall opposite the first wall, and a fluid flow passage disposed between the first wall and the second wall and in fluid communication with the inlet and the outlet;
a port extending into the fluid flow passage and through the first wall along a first axis, the port to communicate with a chamber that receives powder during a printing operation; and
a plate disposed within the fluid flow passage and axially spaced between the port and the second wall along the first axis such that the fluid flow passage is divided into a first passage between the port and the plate and a second passage between the plate and the second wall, wherein the first passage is to receive powder from the chamber through the port.

7. The system of claim 6, wherein the inlet and the outlet are coaxially aligned along a second axis, wherein the first axis is disposed within a plane that extends perpendicularly to the second axis, and wherein the plate extends radially relative to the first axis.

8. The system of claim 7, wherein the plate has a larger radial cross-sectional area than the port with respect to the first axis.

9. The system of claim 8, wherein the fluid flow passage is to facilitate radially directed fluid flow across the plate and between the inlet and the outlet with respect to the first axis.

10. The system of claim 9, wherein the fluid flow passage comprises:
an inlet section including the inlet;
a central section; and
an outlet section including the outlet;
wherein the outlet section is in fluid communication with the inlet section through the central section,
wherein the plate is disposed in the central section, and
wherein the inlet section converges from the inlet toward the central section and the outlet section diverges from the central section toward the outlet.

11. The system of claim 9, wherein the first axis extends vertically, and wherein the second axis is orthogonal to the first axis.

12. The system of claim 9, comprising a reservoir that is in fluid communication with the outlet of the fluid flow device.

13. A system, comprising:
a build surface to support a three-dimensional printed object;
a plurality of chambers disposed adjacent the build surface, each chamber to receive material from the build surface;
a plurality of fluid flow devices, wherein each fluid flow device is coupled to one of the chambers and wherein each fluid flow device comprises:
a body comprising an inlet, an outlet, a first wall, a second wall opposite the first wall, and a fluid flow passage disposed between the first wall and the second wall and in fluid communication with the inlet and the outlet;
a port extending into the fluid flow passage and through the first wall along a first axis, the port to communicate with a chamber that receives powder during a printing operation; and
a plate disposed within the fluid flow passage and axially spaced between the port and the second wall along the first axis such that the fluid flow passage is divided into a first passage between the port and the plate and a second passage between the plate and the second wall, wherein the first passage is to receive powder from the chamber through the port; and
a reservoir in communication with the outlet of each fluid flow device.

14. The system of claim 13, wherein, for each fluid flow device, the plate extends radially relative to the central axis.

15. The system of claim 14, wherein, for each fluid flow device, the plate has a larger radial cross-sectional area than the port.
